(19) United States
(12) Patent Application Publication
(10) Pub. No.: US 2025/0124552 A1
(43) Pub. Date: Apr. 17, 2025

(54) SIMPLIFIED METHOD AND SYSTEM FOR DENOISING INFRARED IMAGE BY USING NON-LOCAL MEANS (NLMEANS) BASED ON FIELD PROGRAMMABLE GATE ARRAY (FPGA), MEDIUM, AND DEVICE

(71) Applicant: SHANGHAI RACING VISUAL ARTS AND SCIENCE TECHNOLOGY CO., LTD., Shanghai (CN)

(72) Inventors: Yan LUO, Shanghai (CN); Bing LUO, Shanghai (CN); Jianghui LI, Shanghai (CN); Chengzhi CHEN, Shanghai (CN); Lei ZHANG, Shanghai (CN)

(73) Assignee: SHANGHAI RACING VISUAL ARTS AND SCIENCE TECHNOLOGY CO., LTD., Shanghai (CN)

(21) Appl. No.: 18/754,204

(22) Filed: Jun. 26, 2024

Related U.S. Application Data
(63) Continuation of application No. PCT/CN2023/139435, filed on Dec. 18, 2023.

(30) Foreign Application Priority Data
Oct. 13, 2023 (CN) 202311332049.2

(51) Int. Cl. G06T 5/70; G06V 10/74

(52) U.S. Cl. CPC G06T 5/70; G06V 10/761; G06T 2207/10048; G06T 2207/20182

(57) ABSTRACT

A simplified method and system for denoising an infrared image by using non-local means (NLMeans) based on a field programmable gate array (FPGA), a medium, and a device are provided. The method includes: step S1: determining a size of a search window and a size of a matching window; step S2: performing linear superposition on a Manhattan distance and a Chebyshev distance to calculate a similarity between each matching block and a central block; and step S3: calculating a weight of each matching block based on the similarity, and calculating a current denoising result based on each matching block and the corresponding weight. The method can basically maintain a noise denoising effect of original NLMeans, and enable the NLMeans to be easily implemented on an FPGA.

### CROSS REFERENCE TO THE RELATED APPLICATIONS

This application is the continuation application of International Application No. PCT/CN2023/139435, filed on Dec. 18, 2023, which is based upon and claims priority to Chinese Patent Application No. 202311332049.2, filed on Oct. 13, 2023, the entire contents of which are incorporated herein by reference.

### TECHNICAL FIELD

The present disclosure relates to the technical field of denoising an infrared image, and specifically, to a simplified method and system for denoising an infrared image by using non-local means (NLMeans) based on a field programmable gate array (FPGA), a medium, and a device.

### BACKGROUND

At present, infrared imaging technology has been widely applied in military, industrial, agricultural, and other fields. Increasing application demands have put forward a higher requirement for quality of an infrared image. However, affected by factors such as a detector material, processing method, and external environment, the infrared image often contains some noise, which not only reduces the quality of the infrared image but also affects extraction of effective information in the infrared image. Numerous studies have been conducted on denoising of the infrared image in the industry, and NLMeans is one of most effective denoising algorithms.

Many infrared devices are portable devices. Therefore, many infrared devices are based on an FPGA platform to implement an algorithm, which can well meet a usage demand of a real-time scene. However, an FPGA has a certain resource limitation and cannot perform particularly complex floating-point process calculation. Therefore, some algorithms have complex calculation processes and are inconveniently implemented on the FPGA.

The patent document CN107590783A (application No. 201710754287.0) discloses an FPGA-based image denoising method, including: inputting image data into a template generation module, processing row data of a video image by using a 1×7 neighborhood template, and calculating the corresponding noise variance based on an amplitude of input noise; performing, by using a median filtering module, median filtering on seven rows of generated original image data and the noise variance, calculating medians of original video image data under four types of strides as well as the respective corresponding noise variance medians, and outputting a result to a data analysis and selection module; calculating a range of an image signal for each stride based on video image data and noise variances corresponding to different strides, and selecting an optimal stride based on the range; and outputting data through a data output module.

In response to the above problems, based on a special structure of the FPGA and a traditional NLMeans denoising algorithm, the present disclosure provides a simplified algorithm for denoising the infrared image by using the NLMeans based on the FPGA. This algorithm can effectively remove noise from an original infrared image and can be easily implemented on the FPGA.

### SUMMARY

In order to overcome the defects in the prior art, the present disclosure is intended to provide a simplified method and system for denoising an infrared image by using NLMeans based on an FPGA, a medium, and a device.

A simplified method for denoising an infrared image by using NLMeans based on an FPGA is provided according to the present disclosure, including:
step S1: determining a size of a search window and a size of a matching window;
step S2: performing linear superposition on a Manhattan distance and a Chebyshev distance to calculate a similarity between each matching block and a central block; and
step S3: calculating a weight of each matching block based on the similarity, and calculating a current denoising result based on each matching block and the corresponding weight.

Preferably, the step S1 includes: determining the size of the search window as N*N and the size of the matching window as d*d, where when N=11 and d=3, there are a total of 81 matching blocks.

Preferably, in the step S2, a following formula is adopted:

$${S}_{i} = ( 1 - a ) \sum \vert {a}_{i} - {b}_{i} \vert + a max ( \vert {a}_{i} - {b}_{i} \vert ) ,$$

where Sᵢ represents the similarity; α represents a parameter, and each of αᵢ and bᵢ represents a pixel value of an image block; and the subscript i represents a same position in two image blocks, where i=1,2 . . . ,9.

A simplified system for denoising an infrared image by using NLMeans based on an FPGA is provided according to the present disclosure, including:
a module M1 configured to determine a size of a search window and a size of a matching window;
a module M2 configured to perform linear superposition on a Manhattan distance and a Chebyshev distance to calculate a similarity between each matching block and a central block; and
a module M3 configured to calculate a weight of each matching block based on the similarity, and calculate a current denoising result based on each matching block and the corresponding weight.

Preferably, the module M1 determines the size of the search window as N*N and the size of the matching window as d*d; and when N=11 and d=3, there are a total of 81 matching blocks.

Preferably, the module M2 adopts a following formula:

$${S}_{i} = ( 1 - a ) \sum \vert {a}_{i} - {b}_{i} \vert + a max ( \vert {a}_{i} - {b}_{i} \vert ) ,$$

where Sᵢ represents the similarity; α represents a parameter, and each of αᵢ and bᵢ represents a pixel value of an image block; and the subscript i represents a same position in two image blocks, where i=1,2 . . . ,9.

A computer-readable storage medium storing a computer program is provided according to the present disclosure, where the computer program is executed by a processor to perform the steps of the method described above.

An electronic device is provided according to the present disclosure, including a memory, a processor, and a computer program stored in the memory and executable in the processor, where the computer program is executed by the processor to perform the steps of the simplified method for denoising an infrared image by using NLMeans based on an FPGA.

Compared with the prior art, the present disclosure has following beneficial effects:
1. The method in the present disclosure can basically maintain a noise denoising effect of original NLMeans, and enable the NLMeans to be easily implemented on an FPGA.
2. A higher calculation speed is achieved, which is beneficial for improving denoising efficiency of an infrared image.

### BRIEF DESCRIPTION OF THE DRAWINGS

Other features, objectives, and advantages of the present disclosure will become more apparent by reading the detailed description of non-limiting embodiments with reference to the following accompanying drawings.

FIG. 1 schematically shows point distributions of four methods at a same distance; and

FIGS. 2A-2D show the comparison of algorithms in the present disclosure.

### DETAILED DESCRIPTION OF THE EMBODIMENTS

The present disclosure is described in detail below with reference to specific embodiments. The following embodiments will help those skilled in the art to further understand the present disclosure, but do not limit the present disclosure in any way. It should be noted that several variations and improvements can also be made by a person of ordinary skill in the art without departing from the conception of the present disclosure. These all fall within the protection scope of the present disclosure.

The present disclosure provides a simplified method and system for denoising an infrared image by using NLMeans based on an FPGA, so as to optimize a traditional NLMeans denoising algorithm, such that the optimized NLMeans denoising algorithm can be easily implemented on an FPGA without affecting a denoising effect. NLMeans is a commonly used image denoising algorithm. The original NLMeans algorithm involves complex floating-point calculation and Euclidean distance calculation. The floating-point calculation and the Euclidean distance calculation can be easily implemented on a general processor. However, when implemented on the FPGA, the floating-point calculation and the Euclidean distance calculation require a lot of resources and affect a processing speed. Therefore, in order to better implement the NLMeans algorithm on the FPGA, an original algorithm process needs to be simplified. The present disclosure mainly simplifies distance calculation. An experimental result shows that the method in the present disclosure can basically maintain a noise denoising effect of the original NLMeans, and enable the NLMeans to be easily implemented on the FPGA.

### Embodiment 1

A simplified method for denoising an infrared image by using NLMeans based on an FPGA is provided according to the present disclosure, including following steps:

Step 1: A size of a search window and a size of a matching window are determined.

Step 2: Linear superposition is performed on a Manhattan distance and a Chebyshev distance to calculate a similarity between each matching block and a central block.

Step 3: A weight of each matching block is calculated based on the similarity.

Step 4: A current denoising result is calculated based on each matching block and the corresponding weight.

Specifically, the step 1 includes:
assuming that N=11 and d=3, there are a total of 81 matching blocks.

Specifically, in the step 2, similarity Si between matching block Pi (i=1, . . . , 81) and the center block Q is calculated. Original NLMeans adopts Euclidean distance calculation (method 1). However, due to complexity of calculation of a sum of squares, Manhattan distance calculation is directly adopted for simplification (method 2), but an effect loss is relatively large.

Pixels corresponding to two image blocks are calculated:

Method 1: Si=sqrt (Σ(αᵢ−bᵢ)²), where the Euclidean distance calculation is adopted (this method is a method used in a standard NLMeans algorithm).

Method 2: Si=Σ|αᵢ−bᵢ|, where the Manhattan distance calculation is adopted.

Method 3: Si=max (|αᵢ−bᵢ|), where Chebyshev distance calculation is adopted.

Method 4: Si=(1−α)Σ|αᵢ−bᵢ|+αmax(|αᵢ−bᵢ|), where linear superposition is performed on a Manhattan distance and a Chebyshev distance.

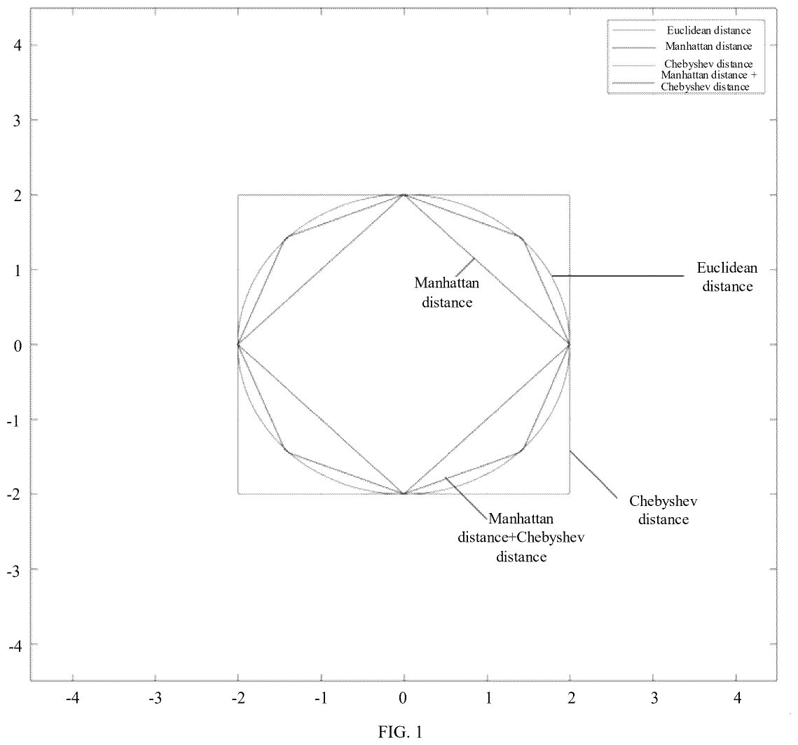

As shown in FIG. 1, it can be seen that a result of the method 4 is closest to a result of the method 1.

In the step 3, the weight is calculated based on the similarity, in other words,

$${Q}_{c} = \frac{{Σ}_{i = 1}^{81} P {i}_{c} \cdot w ( {S}_{i} )}{{Σ}_{i = 1}^{81} w ( {S}_{i} )} ,$$

where σ represents a level of image noise. A lookup table is created based on the Si to obtain a value of w. For example, if a value range of the Si is 0˜100000, because σ is a fixed value, corresponding to 0˜100000, the corresponding w can be calculated and stored in a table. In actual use, the value of the w can be searched based on a value of the Si.

In the step 4, a denoising result of a central pixel of the central block Q is calculated according to

$$w ( {S}_{i} ) = {e}^{\frac{- {{S}_{i}}^{2}}{2 {σ}^{2}}} ,$$

where Pi_{c} represents a center pixel of an i^{th} matching block.

Therefore, a process of the original NLMeans is simplified to better adapt to implementation on the FPGA without causing a significant impact on an effect.

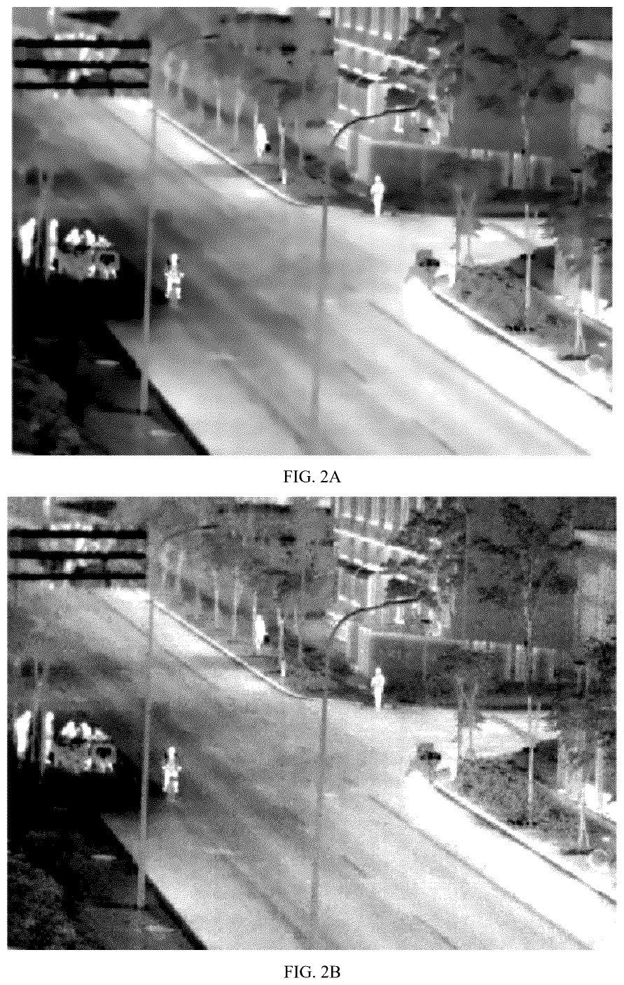

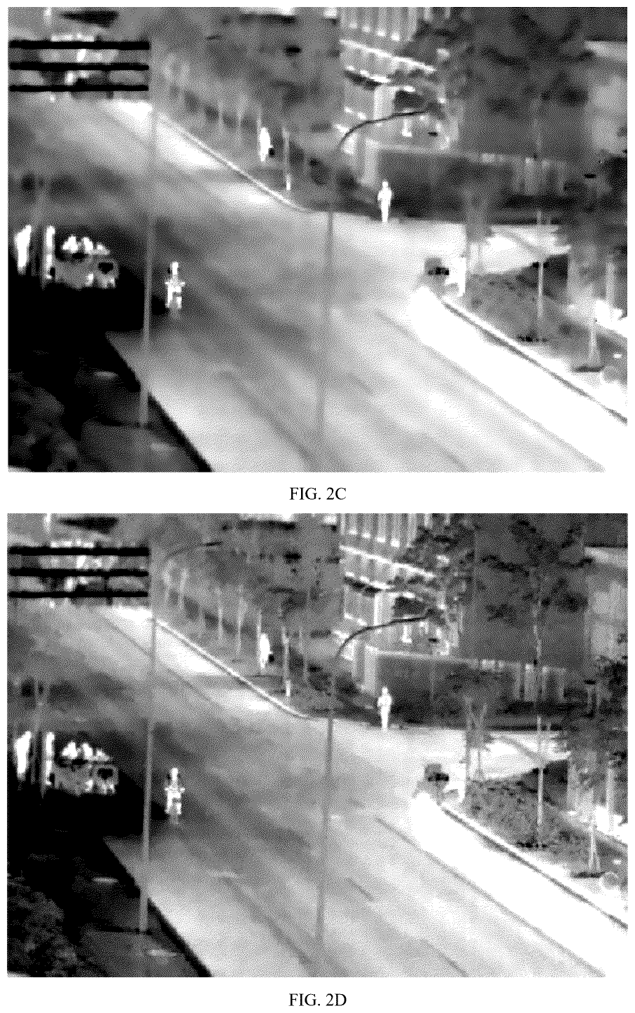

The method 1 is an effect of the original NLMeans, the method 2 adopts the Manhattan distance calculation, the method 3 adopts the Chebyshev distance calculation, and the method 4 combines the Manhattan distance and the Chebyshev distance in the present disclosure. The method 4 has an effect closer to the effect of the original NLMeans and simplifies square calculation. Specific effects are shown in FIGS. 2A-2D. FIG. 2A shows an effect of the method 1; FIG. 2B shows an effect of the method 2; FIG. 2C shows an effect of the method 3; and FIG. 2D shows the effect of the method 4.

A simplified system for denoising an infrared image by using NLMeans based on an FPGA is provided according to the present disclosure, including:
module 1 configured to determine a size of a search window and a size of a matching window;
module 2 configured to perform Linear superposition on a Manhattan distance and a Chebyshev distance to calculate a similarity between each matching block and a central block;
module 3 configured to calculate a weight of each matching block based on the similarity; and
module 4 configured to calculate a current denoising result based on each matching block and the corresponding weight.

Specifically, in the module 1:
assuming that N=11 and d=3, there are a total of 81 matching blocks.

Specifically, the module 2 calculates similarity Si between matching block Pi (i=1, . . . , 81) and the central block Q. Original NLMeans adopts Euclidean distance calculation (method 1). However, due to complexity of calculation of a sum of squares, Manhattan distance calculation is directly adopted for simplification (method 2), but an effect loss is relatively large.

Pixels corresponding to two image blocks are calculated:
Method 1: Si=sqrt (Σ(αᵢ−bᵢ)²), where the Euclidean distance calculation is adopted (this method is a method used in a standard NLMeans algorithm).
Method 2: Si=Σ|αᵢ−bᵢ|, where the Manhattan distance calculation is adopted.
Method 3: Si=max (|αᵢ−bᵢ|), where Chebyshev distance calculation is adopted.
Method 4: Si=(1−α)Σ|αᵢ−bᵢ|+αmax(|αᵢ−bᵢ|), where linear superposition is performed on a Manhattan distance and a Chebyshev distance.

As shown in FIG. 1, it can be seen that a result of the method 4 is closest to a result of the method 1.

The module 3 calculates the weight based on the similarity, in other words,

$$w ( {S}_{i} ) = {e}^{\frac{- {{S}_{i}}^{2}}{2 {σ}^{2}}} ,$$

where σ represents a level of image noise. A lookup table is created based on the Si to obtain a value of w. For example, if a value range of the Si is 0˜100000, because σ is a fixed value, corresponding to 0˜100000, the corresponding w can be calculated and stored in a table. In actual use, the value of the w can be searched based on a value of the Si.

The module 4 calculates a denoising result of a central pixel of the central block Q according to

$${Q}_{c} = \frac{{Σ}_{i = 1}^{81} P {i}_{c} \cdot w ( {S}_{i} )}{{Σ}_{i = 1}^{81} w ( {S}_{i} )} ,$$

where Pi_{c} represents a center pixel of an i^{th} matching block.

Therefore, a process of the original NLMeans is simplified to better adapt to implementation on the FPGA without causing a significant impact on an effect.

The method 1 is an effect of the original NLMeans, the method 2 adopts the Manhattan distance calculation, the method 3 adopts the Chebyshev distance calculation, and the method 4 combines the Manhattan distance and the Chebyshev distance in the present disclosure. The method 4 has an effect closer to the effect of the original NLMeans and simplifies square calculation. Specific effects are shown in FIGS. 2A-2D. FIG. 2A shows an effect of the method 1; FIG. 2B shows an effect of the method 2; FIG. 2C shows an effect of the method 3; and FIG. 2D shows the effect of the method 4.

A computer-readable storage medium storing a computer program is provided according to the present disclosure, where the computer program is executed by a processor to perform the steps of the method described above.

An electronic device is provided according to the present disclosure, including a memory, a processor, and a computer program stored in the memory and executable in the processor, where the computer program is executed by the processor to perform the steps of the simplified method for denoising an infrared image by using NLMeans based on an FPGA.

Those skilled in the art are aware that in addition to being realized by using pure computer-readable program code, the system, the apparatus, and each module thereof provided in the present disclosure can realize a same program in a form of a logic gate, a switch, an application-specific integrated circuit, a programmable logic controller, or an embedded microcontroller by performing logic programming on the method steps. Therefore, the system, the apparatus, and each module thereof provided in the present disclosure can be regarded as a kind of hardware component. The module included therein for realizing each program can also be regarded as a structure in the hardware component; and the module for realizing each function can also be regarded as a software program for implementing the method or a structure in the hardware component.

The specific embodiments of the present disclosure are described above. It should be understood that the present disclosure is not limited to the above specific implementations, and a person skilled in the art can make various variations or modifications within the scope of the claims without affecting the essence of the present disclosure. The embodiments of the present disclosure and features in the embodiments may be arbitrarily combined with each other in a non-conflicting situation.

1. A simplified method for denoising an infrared image by using non-local means (NLMeans) based on a field programmable gate array (FPGA), comprising:
step S1: determining a size of a search window and a size of a matching window;
step S2: performing linear superposition on a Manhattan distance and a Chebyshev distance to calculate a similarity between each matching block and a central block; and
step S3: calculating a weight of each matching block based on the similarity, and calculating a current denoising result based on each matching block and the weight.

2. The simplified method for denoising the infrared image by using NLMeans based on the FPGA according to claim 1, wherein the step S1 comprises: determining the size of the search window as N*N and the size of the matching window as d*d, wherein when N=11 and d=3, there are a total of 81 matching blocks.

3. The simplified method for denoising the infrared image by using NLMeans based on the FPGA according to claim 1, wherein in the step S2, a following formula is adopted:
$${S}_{i} = ( 1 - a ) \sum \vert {a}_{i} - {b}_{i} \vert + a max ( \vert {a}_{i} - {b}_{i} \vert ) ,$$
wherein Sᵢ represents the similarity; α represents a parameter, and each of αᵢ and bᵢ represents a pixel value of an image block; and a subscript i represents a same position in two image blocks.

4. A simplified system for denoising an infrared image by using NLMeans based on an FPGA, comprising:
a first module configured to determine a size of a search window and a size of a matching window;
a second module configured to perform linear superposition on a Manhattan distance and a Chebyshev distance to calculate a similarity between each matching block and a central block; and
a third module configured to calculate a weight of each matching block based on the similarity, and calculate a current denoising result based on each matching block and the weight.

5. The simplified system for denoising the infrared image by using NLMeans based on the FPGA according to claim 4, wherein the first module determines the size of the search window as N*N and the size of the matching window as d*d; and when N=11 and d=3, there are a total of 81 matching blocks.

6. The simplified system for denoising the infrared image by using NLMeans based on the FPGA according to claim 4, wherein the second module adopts a following formula:
$${S}_{i} = ( 1 - a ) \sum \vert {a}_{i} - {b}_{i} \vert + a max ( \vert {a}_{i} - {b}_{i} \vert ) ,$$
wherein S; represents the similarity; α represents a parameter, and each of αᵢ and bᵢ represents a pixel value of an image block; and a subscript i represents a same position in two image blocks.

7. A computer-readable storage medium storing a computer program, wherein the computer program is executed by a processor to perform steps of the simplified method for denoising the infrared image by using NLMeans based on the FPGA according to claim 1.

8. An electronic device, comprising a memory, a processor, and a computer program stored in the memory and executable in the processor, wherein the computer program is executed by the processor to perform steps of the simplified method for denoising the infrared image by using NLMeans based on the FPGA according to claim 1.

9. The computer-readable storage medium according to claim 7, wherein the step S1 comprises: determining the size of the search window as N*N and the size of the matching window as d*d, wherein when N=11 and d=3, there are a total of 81 matching blocks.

10. The computer-readable storage medium according to claim 7, wherein in the step S2, a following formula is adopted:
$${S}_{i} = ( 1 - a ) \sum \vert {a}_{i} - {b}_{i} \vert + a max ( \vert {a}_{i} - {b}_{i} \vert ) ,$$
wherein Sᵢ represents the similarity; α represents a parameter, and each of αᵢ and bᵢ represents a pixel value of an image block; and a subscript i represents a same position in two image blocks.

11. The electronic device according to claim 8, wherein the step S1 comprises: determining the size of the search window as N*N and the size of the matching window as d*d, wherein when N=11 and d=3, there are a total of 81 matching blocks.

12. The electronic device according to claim 8, wherein in the step S2, a following formula is adopted:
$${S}_{i} = ( 1 - a ) \sum \vert {a}_{i} - {b}_{i} \vert + a max ( \vert {a}_{i} - {b}_{i} \vert ) ,$$
wherein Sᵢ represents the similarity; α represents a parameter, and each of αᵢ and bᵢ represents a pixel value of an image block; and a subscript i represents a same position in two image blocks.
